(19) United States
(12) Patent Application Publication
(10) Pub. No.: US 2006/0095639 A1
(43) Pub. Date: May 4, 2006

(54) Structures and methods for proximity communication using bridge chips

(76) Inventors: Bruce M. Guenin, San Diego, CA (US); Arthur R. Zingher, Mountain View, CA (US); Ronald Ho, Mountain View, CA (US); Nyles I. Nettleton, Campbell, CA (US); Ashok V. Krishnamoorthy, San Diego, CA (US); John E. Cunningham, San Diego, CA (US)

Correspondence Address: SUN MICROSYSTEMS INC.;C/O PARK, VAUGHAN & FLEMING LLP, 2820 FIFTH STREET, DAVIS, CA, 95616, US

(21) Appl. No.: 11/264,956

(22) Filed: Nov. 1, 2005

Related U.S. Application Data
(60) Provisional application No. 60/624,720, filed on Nov. 2, 2004.

(51) Int. Cl. G06F 13/36

(52) U.S. Cl. 710/310

(57) ABSTRACT

One embodiment of the present invention provides a system that facilitates proximity communication using a bridge chip. This system includes a base chip with an active face, upon which active circuitry and signal pads reside, and a back face opposite the active face. The bridge chip is mounted to the base chip using a mounting, interconnection, and communication structure. The bridge chip is positioned so that a free end is proximate to a neighboring chip, thereby supporting proximity communication between the base chip and the neighboring chip.

### RELATED APPLICATION

This application claims priority under 35 U.S.C. 119(e) to U.S. Provisional Application Ser. No. 60/624,720, entitled “Bridge Chip for Proximity Communication Between ICs in a Co-Planar Array,” by inventors Arthur R. Zingher, Bruce M. Guenin, Ronald Ho, Nyles I. Nettleton, Ashok V. Krishnamoorthy, and John E. Cunningham, filed on Nov. 2, 2004, the contents of which are herein incorporated by reference (Attorney Docket No. SUN05-0370PSP).

### GOVERNMENT LICENSE RIGHTS

This invention was made with United States Government support under Contract No. NBCH020055 awarded by the Defense Advanced Research Projects Administration. The United States Government has certain rights in the invention.

### BACKGROUND

1. Field of the Invention

The present invention generally relates to semiconductor integrated circuits. More specifically, the present invention relates to structures and methods for proximity communication using bridge chips.

2. Related Art

Researchers have begun to investigate alternative techniques for communicating between semiconductor chips. One promising technique involves integrating arrays of capacitive transmitters and receivers onto semiconductor chips to facilitate inter-chip communication. If a first chip is situated face-to-face with a second chip so that transmitter pads on the first chip are capacitively coupled with receiver pads on the second chip, it becomes possible to transmit data signals directly from the first chip to the second chip without having to route the data signals through intervening signal lines within a printed circuit board.

The effectiveness of capacitive coupling depends on the relative position of the transmitter pads and the receiver pads, both in a plane defined by the pads and in a direction perpendicular to the plane. For example, misalignment in the plane may cause each receiving pad to span two transmitting pads, thereby destroying a received signal. In theory, satisfactory communication requires that any misalignment is less than half of a pitch between the pads. However, in practice, the alignment requirements may be more stringent. In addition, limiting overall misalignment may improve communication performance between the chips and reduce power consumption.

Unfortunately, it is not a simple matter to align the chips properly using existing mounting structures, such as conventional single-chip modules or conventional multi-chip modules. The chips in these structures are subject to thermal expansion and mechanical vibrations, as well as manufacturing and assembly perturbations that cause alignment problems. Furthermore, a need to deliver power and cooling to chips that communicate through proximity communication further complicates chip alignment.

Hence, what is needed are structures and methods for proximity communication that do not interfere with alignment, power delivery, and heat-removal functions.

### SUMMARY

One embodiment of the present invention provides a system that facilitates proximity communication using a bridge chip. This system includes a base chip with an active face, upon which active circuitry and signal pads reside, and a back face opposite the active face. The bridge chip is mounted to the base chip using a mounting, interconnection, and communication structure. This bridge chip is positioned so that a free end is proximate to a neighboring chip, thereby supporting proximity communication between the base chip and the neighboring chip.

In a variation on this embodiment, the bridge chip communicates with the neighboring chip using proximity communication techniques that can include:
capacitive coupling across a thin gap using mating sets of capacitors;
optical communication using mating sets of optical transmitters and optical receivers;
magnetic coupling using mating sets of electromagnets;
short-wavelength microwave radiation; and/or
electromagnetic signals using mating sets of electromagnetic transmitters and receivers, wherein the electromagnetic signals may use various bands and modes of the electromagnetic spectrum.

In a variation on this embodiment, the bridge chip is mounted either to a corner or a side of the base chip.

In a variation on this embodiment, the bridge chip can have two, three, or four ends, wherein a bridge chip with two ends resembles a rectangle or a capital ‘I’, a bridge chip with three ends resembles a capital ‘Y’, and a bridge chip with four ends resembles a capital ‘X’ or a small square.

In a variation on this embodiment, the bridge chip is thin enough to bend in the z-direction.

In a further variation, the bridge chip includes wiring deposited on a face of the bridge chip. This wiring should be compliant and may include a spring layer that can bend elastically in the z-direction.

In a variation on this embodiment, the bridge chip primarily supports communication, and thereby consumes less power than chips that support both computation and communication. Moreover, bridge chips can facilitate the layout of sets of multiple base chips in a single layer, thereby simplifying system design.

In a variation on this embodiment, the mounting and communication structure includes bonded and/or separable mountings for bridge chips.

In a variation on this embodiment, the mounting and communication structure includes mechanisms to support proximity communication and/or conductive communication.

In a variation on this embodiment, circuitry within the bridge chip can be either active or passive.

In a further variation, the mounting and communication structure includes a conductive micro-bump mounting.

### BRIEF DESCRIPTION OF THE FIGURES

FIG. 1 illustrates the bridge chip concept in accordance with an embodiment of the present invention.

FIG. 2 illustrates the scaling of silicon line width and solder bump sizes in accordance with an embodiment of the present invention

FIG. 3A illustrates two chips prior to micro-bump bonding in accordance with an embodiment of the present invention.

FIG. 3B illustrates two chips after micro-bump bonding in accordance with an embodiment of the present invention.

FIG. 4A illustrates a bridge chip that has two ends and resembles a capital ‘I’ in accordance with an embodiment of the present invention.

FIG. 4B illustrates a bridge chip that has three ends and resembles a capital ‘Y’ in accordance with an embodiment of the present invention.

FIG. 4C illustrates a bridge chip that has four ends and resembles a capital ‘X’ in accordance with an embodiment of the present invention.

FIG. 4D illustrates a bridge chip that has four ends and resembles a small square in accordance with an embodiment of the present invention.

FIG. 5A illustrates a base chip and a neighboring chip in accordance with an embodiment of the present invention.

FIG. 5B illustrates a rigid-flex cable bonded to the two chips in accordance with an embodiment of the present invention.

FIG. 5C illustrates a bridge chip between the two chips in accordance with an embodiment of the present invention.

FIG. 5D illustrates attachment structures for a bridge chip in accordance with an embodiment of the present invention.

FIG. 5E illustrates a pair of power delivery structures for a bridge chip in accordance with an embodiment of the present invention.

FIG. 5F illustrates a power delivery structure that spans the entire bridge chip in accordance with an embodiment of the present invention.

FIG. 5G illustrates decoupling capacitors on a bridge chip in accordance with an embodiment of the present invention.

FIG. 6A illustrates a flexible bridge chip in accordance with an embodiment of the present invention.

FIG. 6B illustrates a second view of a flexible bridge chip in accordance with an embodiment of the present invention.

FIG. 7A illustrates a separable bridge chip in accordance with an embodiment of the present invention.

FIG. 7B illustrates a second view of a separable bridge chip in accordance with an embodiment of the present invention.

FIG. 8 illustrates a bridge chip attached on one side to a base chip accordance with an embodiment of the present invention.

FIG. 9A illustrates the alignment forces upon a bridge chip in accordance with an embodiment of the present invention.

FIG. 9B illustrates a second view of the alignment forces upon a bridge chip in accordance with an embodiment of the present invention.

FIG. 10 illustrates attachment forces upon a bridge chip in accordance with an embodiment of the present invention.

FIG. 11A illustrates a single-design host chip with bridge chips attached on two sides in accordance with an embodiment of the present invention.

FIG. 11B illustrates a tiling configuration with two different types of host chips, one of which has four side-mounted bridge chips, in accordance with an embodiment of the present invention.

FIG. 11C illustrates a full cubic array tiling configuration with two different types of host chips, one of which has four corner-mounted bridge chips, in accordance with an embodiment of the present invention.

FIG. 11D illustrates an open cubic array tiling configuration with two different types of host chips, one of which has four corner-mounted bridge chips, in accordance with an embodiment of the present invention.

FIG. 11E illustrates a pinwheel tiling configuration with two different types of host chips in accordance with an embodiment of the present invention.

### DETAILED DESCRIPTION

The following description is presented to enable any person skilled in the art to make and use the invention, and is provided in the context of a particular application and its requirements. Various modifications to the disclosed embodiments will be readily apparent to those skilled in the art, and the general principles defined herein may be applied to other embodiments and applications without departing from the spirit and scope of the present invention. Thus, the present invention is not limited to the embodiments shown, but is to be accorded the widest scope consistent with the principles and features disclosed herein.

Challenges of Proximity Communication

“Proximity communication” makes possible direct chip-to-chip communication through capacitive coupling between mating arrays of pads on two closely-adjacent chips. Proximity communication enables extremely large bandwidth and bandwidth per area of an array, and enables large sets of densely-packed integrated circuit (IC) chips. Such dense packing enables low-latency communication between chips, but also requires packaging structures that can support the injection of many amps of power per unit area and extraction of many watts of heat per unit area. Furthermore, proximity communication requires high precision in the alignment of chips, including x-y alignment (parallel to the chips) as well as z-axis alignment (perpendicular to the chips).

Existing designs that use proximity communication between a number of IC chips are configured with two closely-overlapping layers of carrier chips oriented face-to-face, for instance with the corners of each chip in one layer either in contact with or proximity to the corners of chips in the opposite layer. In such a configuration, electrical power and cooling are supplied separately to the exterior surface of each chip layer. As a result, the power distribution and cooling components serving a given chip layer share the same volume immediately beyond the chip layer, making it more difficult to optimize these separate functions. Such an organization results in severe congestion at the perimeter of multi-chip modules as the power levels of chips and number of chips increase, and sharply mismatches the earlier art of IC packaging.

Existing module designs often include a precision alignment structure. However, when an alignment structure such as a jig plate is co-located with the two chip layers, and as a result does not contact a cooling plate, the temperature of the alignment structure varies according to the power dissipated by the chips in the module. Consequently, to prevent thermal expansion problems, the alignment structure should ideally be composed of low-thermal-expansion materials such as silicon. Furthermore, while the alignment structure provides chip alignment in the x-y plane and in the z dimension, it is limited in thickness to a value not much more than the total thickness of the two chip layers. This limits the rigidity of the alignment structure in response to deformations along the z-axis.

Yet another set of challenges arise from integrating the chip-array voltage-regulator-module (VRM) components (which supply current at the voltage required by the chip array) with the optical or electrical signal cables used by external communication components. Because of the dense packing of chips and the requirement that they be sandwiched between their respective power distribution and cooling components, the only practical location for positioning the VRM components is at the perimeter of the array. Finding the space to integrate both enough VRM components to satisfy the power distribution requirements as well as enough external communication components to satisfy the requirements for high-bandwidth signaling can become a significant challenge. Since the border area of a chip array grows linearly while the area and functionality grow quadratically, existing techniques for communicating between chips and the outside world will not scale as chip and chip array sizes increase.

All of the aforementioned challenges become more difficult as the size of the chip array increases.

Bridge Chips

In the instant invention, proximity communication between neighboring chips is accomplished using small, low-power bridge chips whose primary function is communication. A bridge chip connects to a base chip with either a fixed or a removable connection, and allows communication with one or more neighboring chips. Arrays of proximity communication structures are located on mating areas of at least one of the two chips and at least one end of the bridge chip. The use of bridge chips allows the chips to be arranged in a single, co-planar array, which considerably simplifies the design of multi-chip modules (MCMs) and benefits the module packaging objectives of chip alignment, thermal management, and power distribution. A single co-planar array of chips can enable a multi-chip module in which a rigid-flex cable is used to deliver power to the chips (see patent application Ser. No. 11/250,100 (Attorney Docket No. SUN05-0301), “Multi-Chip Module Structure With Power Delivery Using Flexible Cables,” by Bruce M. Guenin and Nyles I. Nettleton, filed 12 Oct. 2005, which is hereby incorporated by reference).

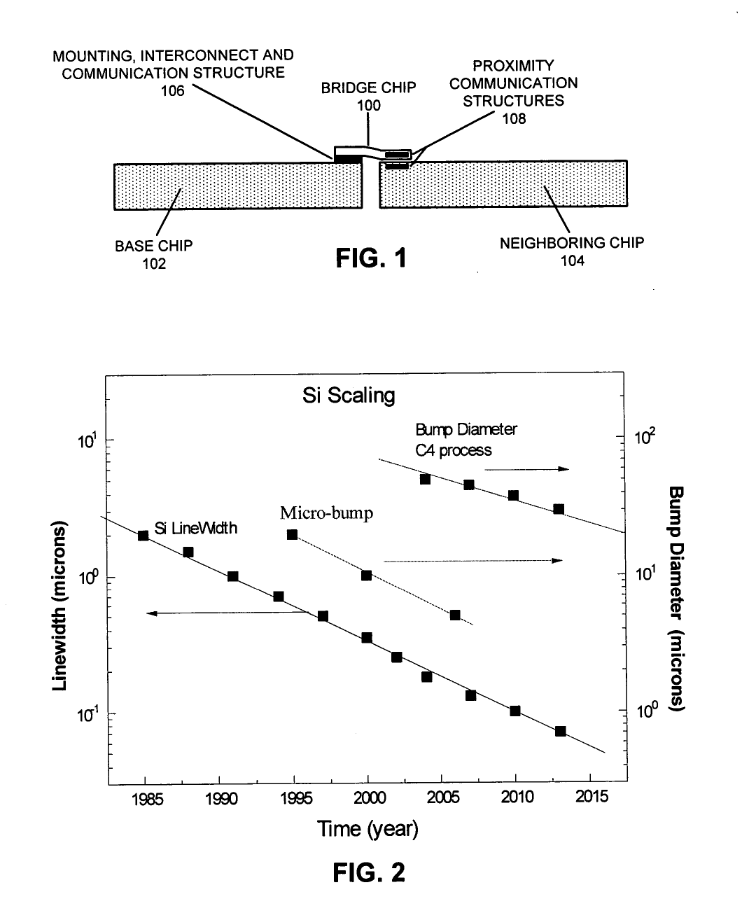

Bridge chips can be either bonded, with one end permanently affixed to a host base chip, or separable, with the bridge chip not mounted but instead supported by an alignment structure. FIG. 1 illustrates a bridge chip 100 bonded to a base chip 102 via a mounting, interconnect, and communication structure 106. This structure provides communication and, if required, adhesive bonding between the two chips and electrical interconnection for signaling and/or power transfer.

The electrical coupling that supports signaling between the two chips can be either non-conductive or conductive; each coupling approach has trade-offs, for instance in complexity of alignment or thermal stress/expansion. Benefits of conductive communication between a bonded bridge chip and base chip include lower latency transmission of digital signals between the chips. In addition, a bonded approach with conductive interconnect typically dissipates less power than a bridge chip with proximity communication at both ends. Note that since the primary function of the bridge chips is proximity communication, they can operate at lower power levels and dissipate less heat than chips that perform both communication and computation functions.

The base chip can both transmit digital signals into the bridge chip and receive signals from it. The free end of the bridge chip is positioned to overlap with a region of a neighboring chip 104 containing proximity communication structures 108. Since the proximity communication circuitry has exacting requirements, the base and neighbor chip are precisely aligned with respect to each other in the x-y plane. As shown in FIG. 1, the top surfaces of the base chip 102 and neighboring chip 104 are maintained at nearly the same height, within a tolerance that depends upon the compliance of the bridge chip and the design of the proximity communication circuitry.

Proximity communication techniques can include:
capacitive coupling across a thin gap using mating sets of capacitors;
optical communication using mating sets of optical transmitters and optical receivers;
magnetic coupling using mating sets of electromagnets;
short-wavelength microwave radiation; and/or
electromagnetic signals using mating sets of electromagnetic transmitters and receivers, wherein the electromagnetic signals may use various bands and modes of the electromagnetic spectrum.
   Mounting of Bridge Chips

When conductive communication is used, the same structure that provides for electrical communication may also function as the mounting mechanism. A popular example of this is the “flip chip,” an IC electrically connected to another chip by an array of solder bumps attached to the top metal layer of each chip. Once the solder bumps have been reflow-soldered and solidify, an “underfill” is often used to strengthen the bond between the two chips and to extend the fatigue life of the solder bump array in face of temperature changes that result from variations in applied power.

In previous electronic packaging art, chips typically have external electronic connections through an area-array of many solder balls. Sometimes these are called “C4”, or “controlled collapse chip connecter,” balls. This technology incurs many limitations, for instance in the feasible density of balls and due to micro-mechanical stresses such as thermal distortion. FIG. 2 illustrates the scaling of silicon line width and solder bump size. Since C4 bumps are based on large bumps that are significantly larger than minimum feature sizes on an electronic chip and do not track the scaling of the minimum feature size of CMOS, an alternative approach was necessary. As a result, a fine-pitch solder bump technology using micro-bumps, which does scale with minimum feature size, is used to mount bridge chips.

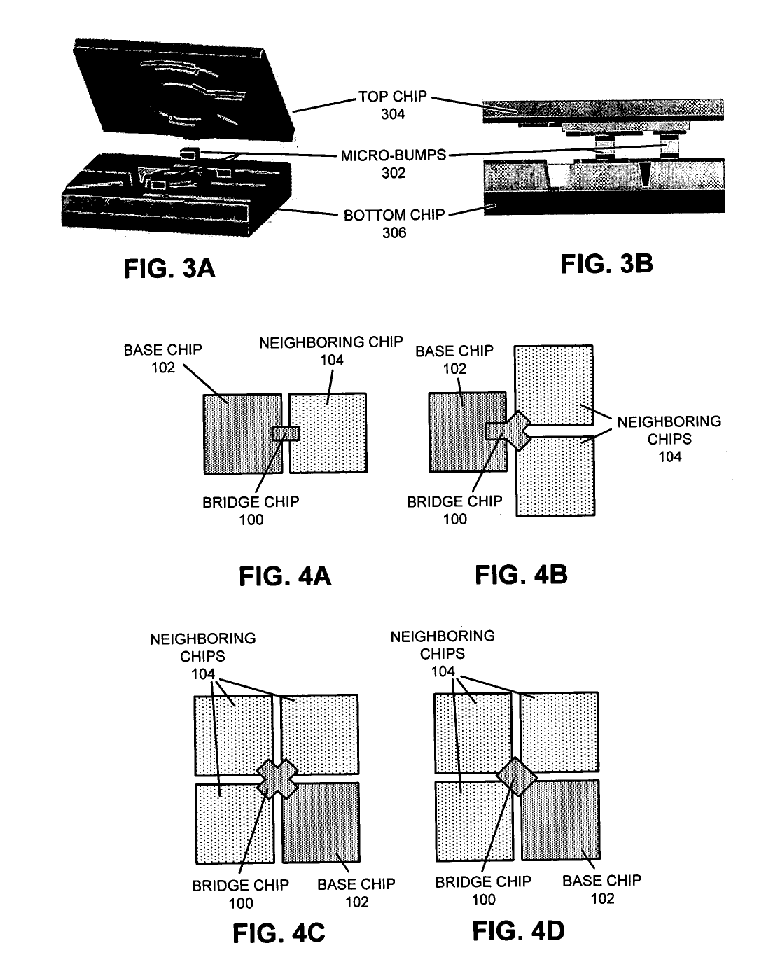

Micro-bump solder technology enables direct attachment of two chips through a flip chip bonding process. The two chips can be very different, since the process is performed as a hybrid integration process. FIG. 3A illustrates two chips prior to micro-bump bonding. The top chip 304 and bottom chip 306 can be composed of quite different circuit functionality, since micro-bumps 302 are formed on the surface of one chip and landing pads formed on the second chip. An arbitrary arrangement of bumps can be implemented, provided they are small. In particular, it is possible to build up micro-bumps directly on device contact pads such as the source or drain of transistor pad geometries (for example, in upper level metal layers of a CMOS process). The landing pads of the second chip can be optional pads or may be a simple conductive via already fabricated on a pitch that matches the first chip. Additionally, dummy pads may be deployed.

Micro-solder also enables a very high density of conductive interconnects between two chips. For instance, a five micron diameter bump on a 10 micron pitch enables 10⁴ interconnects per mm², or about one million interconnects per cm². Additionally, the inter-chip separation can be controlled near the one-micron level, which allows an order of magnitude greater control over chip gap compared to the traditional C4 bumps. Micro-bumps are the least intrusive interconnect for direct chip attachment, and minimize the impact to the functionality of the chips for flip-chip bonding. The low-profile topology (including both height and width) of micro-bumps further minimize angular mis-tilts of during direct chip attachment.

The two chips are joined face-to-face in a step that completes the metallurgical bond of the solder and inter-chip metals (illustrated in FIG. 3B). Intermixing between the metal micro-bumps and contact pads of the transistor and vias is promoted under a low-temperature, high-pressure recipe. Generally, an underfill such as epoxy can optionally be used to maintain adhesion between chips and to further facilitate the bonding. Epoxies can be locally applied to selected areas of the joined chips by using dams that prevent epoxy from flowing into undesirable circuit regions of the chip.

Additional advantages of micro-bumps include:
Micro-bumps use thermal compression bonding, resulting in:
   a. Low bond temperature;
   b. Smaller CTE (co-efficient of thermal expansion) effects;
   c. Increased choice of materials;
   d. No reflow solder steps (flux high, temperature, self-alignment); and
   e. Lead-free bumps (arbitrary bond materials can be used).
Five micron bump diameter are possible with micro-bumps, leading to:
   a. Lower capacitance and inductance;
   b. Parasitics only occurring above 80 gigahertz;
   c. The ability to contact individual device geometries;
   d. No limit to pitches larger than 10 microns; and
   e. The possibility of using multiple dummy bumps for local thermal management.
Micro-bumps allow ultra-small bumps, resulting in:
   a. Aspect ratio that lead to improved reliability;
   b. Better Coffin-Mason fatigue resistance;
   c. A thinner bond-line that results in fewer CTE problems;
   d. Less void formation; and
   e. More effective use of surfactants.
Using micro-bumps allows single-side soldering that:
   a. Simplifies processing; and
   b. Puts less mechanical stress on critical components.
      Non-Conductive Mounting of Bridge Chips

Proximity communication between a bridge chip and base chip can also take place with non-conductive bonding or no bonding at all.

In the case of non-conductive bonding, a number of methods can be used to create a bond between the two passivation layers covering the proximity pads on the bridge and base chip. The primary requirements are that the bonding material is a dielectric, that the bond-line is thin enough, and that the material has a low enough dielectric loss coefficient. The maximum allowed thickness depends upon the size and design of the proximity communication pads. In general, a preferred bond-line thickness would be less than one-half of the proximity pad pitch. An example material that meets these requirements is an aromatic thermosetting copolyester.

There are bonding methods that do not require the addition of a second material to the interface area, but, rather, promote a strong bond between the SiO₂ passivation layers. One such method activates the covalent bonds on the SiO₂ surface. Once these surfaces are activated, the bond is accomplished simply by pressing the two surfaces into contact.

Bridge chip designs with active circuitry require an electrical interconnection between the bridge chip and the base chip. This electrical interconnection is normally created after the mounting process is completed, and the interconnect method should support a fine pitch array structure. A possible method accomplishes this by creating vias through the thickness of the bridge chip before mounting, for instance by a process such as reactive ion etching. After mounting, a flash metal layer is applied to the sides of the via hole using a physical deposition process with appropriate masking. Following this, the thickness of the metal layer is increased through electroplating. The contiguous metal layers on both the bridge and base chips are patterned such that the additive metal layer provides the appropriate electrical connections for power and ground to the circuitry on the bridge chip.

Active vs. Passive Bridge Chips

Proximity communication can be achieved using bridge chips with either active or passive circuitry. Active circuitry refers to circuits which use amplifying semiconductor devices. Passive circuitry comprise merely metal traces and the pads needed for the transmission of signals.

The primary function of active circuitry on the bridge chip is to increase the signal-to-noise ratio for the transmission of signals to and from the base chip to the neighboring chip. Active circuitry is particularly beneficial when bi-directional proximity communication is used between the base and neighboring chip(s) and when the bridge chips span a large gap between the base chip and neighboring chip(s).

Bridge chips may be composed of different materials depending on the design. The integration of active circuitry increases the cost, complexity, and power dissipation of bridge chips, and tends to limit the choice of fabrication materials. For instance, a bridge chip requiring active circuitry typically uses a semiconductor, often silicon, while a passive bridge chip not requiring amplification might be made out of other non-semiconductor materials.

Bridge chips using passive circuitry face a greater challenge in maintaining acceptable signals than those using active circuitry. However, as mentioned above, passive circuitry provides a wider choice of materials and dissipates less power on the bridge chip than active circuitry.

The communication challenges of passive bridge chips depend on the direction of transmission. For one direction of communication, the base chip transmits data onto the bridge chip, across the bridge chip, and into a neighboring chip via proximity communication pads. In this case, because the driving transmitters reside on the base chip, voltage signals sent across the bridge chip are un-refreshed and left vulnerable to coupled noise from external sources or adjacent traces on the bridge chip. In addition, the lack of active repeaters on the bridge chip implies higher signal latency if the bridge chip is sufficiently long.

Designers can mitigate such deleterious effects through a combination of:
metal twists on differential wires to reduce noise;
matched-impedance transmission lines on the bridge chip to reduce latency; and/or
increased voltage swing on the driving base chip to improve both noise and latency.

For a second direction of communication, a neighboring chip may transmit data back to the base chip. Such data first crosses proximity communication pads, then travels though the bridge chip, and finally arrives at the base chip. In this case, the signals see the same problems as in the first case above, but with dramatically reduced voltage levels. Data sent from a neighboring chip across a proximity communication link will be reduced in signal amplitude (and hence signal-to-noise ratio) by a factor equal to the ratio of the chip-to-chip coupling capacitance to the bridge chip capacitance. For long bridge chips, this can easily reduce the voltage amplitude by a factor of ten or more, exacerbating the delay and noise sensitivities detailed above.

From a signaling perspective, using unidirectional bridge chips provides the highest data performance. In such chips, data flows only from a base chip to a neighboring chip, and two-way communication between two adjacent base chips would require two unidirectional bridge chips, each mounted to one of the base chips. A drawback of this approach is that the process of assembling the base chips into an array is challenging because of the mechanical interference of the two bridge chips.

Bendable Bridge Chips and Bridge Chip Alignment Issues

A variety of techniques are used to facilitate the alignment of chips for proximity communication. Z-bendability in an IC, particularly a bridge chip between a base chip and a neighboring chip, allows for simpler alignment in the z-axis. Such bendability can be achieved using a bridge chip that is thin enough to bend elastically in the z-direction. In a preferred embodiment, such as a silicon chip about 20 microns thin, this bending is fully elastic. In other versions, the bend may include inelastic deformation, such as a bridge chip that includes some plastic, soft metal, or even gallium arsenide. Another embodiment uses wiring deposited on the face of an IC chip that may include a spring layer. This wiring, some of which is not adhered to the bridge chip in the area of the proximity communication array, is compliant. The compliancy in the wiring allows the wiring to remain in contact or near contact with proximity communication pads in the neighboring chip through a range of z-positions for the top surface of the host chip.

Other techniques can be used to reduce alignment issues. Receive pads are often larger than transmit pads, to reduce the likelihood of transmission overlap. The pairing of receive and transmit pads can also be dynamically re-assigned depending on the x and y alignment of the chips. The physical array of terminals can be significantly finer than the logical array of terminals, allowing routing switches to select physical terminals and electronically connect them into larger logical terminals. Additionally, sensors can be used to measure the signal coupling between logical terminals on the adjacent chip. Such capacitive sensing can be used as a yardstick to measure how chips have moved in relation to each other, after which the pads can be re-aligned by re-routing communication links based on pad proximity. Such electronic self-alignment techniques relax the mechanical alignment requirements.

Bridge Chip Examples and Tiling Patterns

Bridge chips can be attached to the sides of host chips as well as to the corners. A bridge chip can have two, three, or four ends to link together a number of neighboring chips. FIG. 4A illustrates a side-mounted bridge chip that has two ends and resembles a rectangle. A bridge chip with two ends might also resemble a capital ‘I’. FIG. 4B illustrates a side-mounted bridge chip that has three ends and resembles a capital ‘Y’. FIG. 4C illustrates a corner-mounted bridge chip that has four ends and resembles a capital ‘X’. FIG. 4D illustrates a corner-mounted bridge chip that has four ends and resembles a small square.

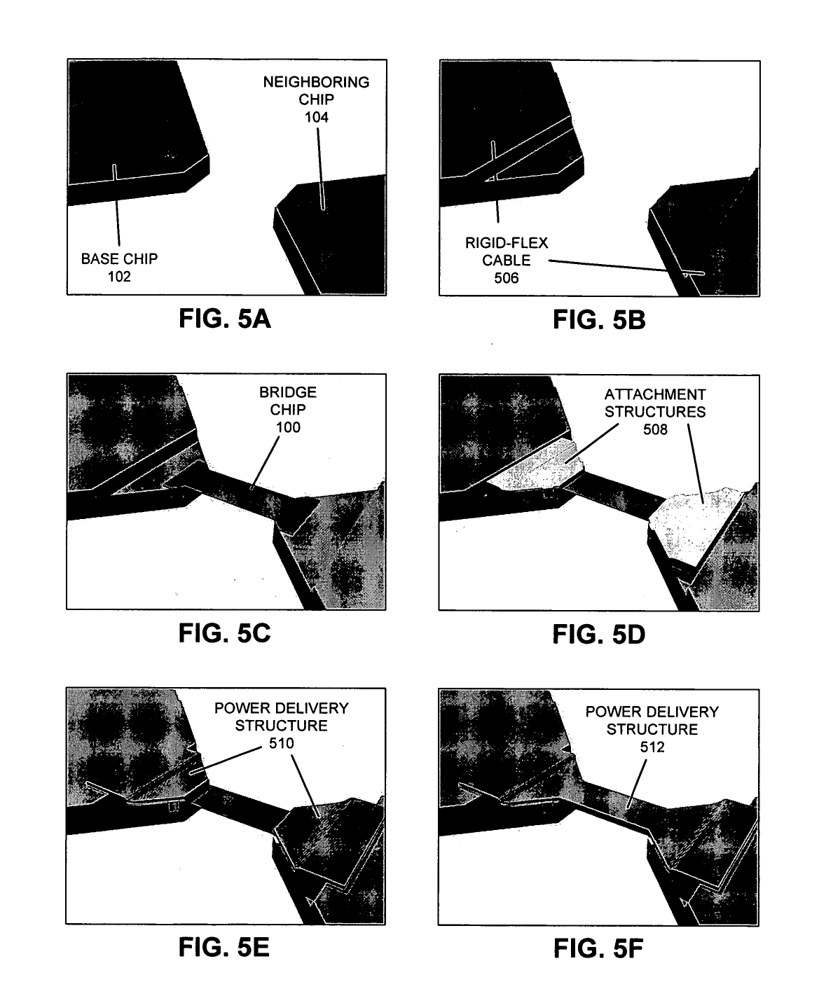

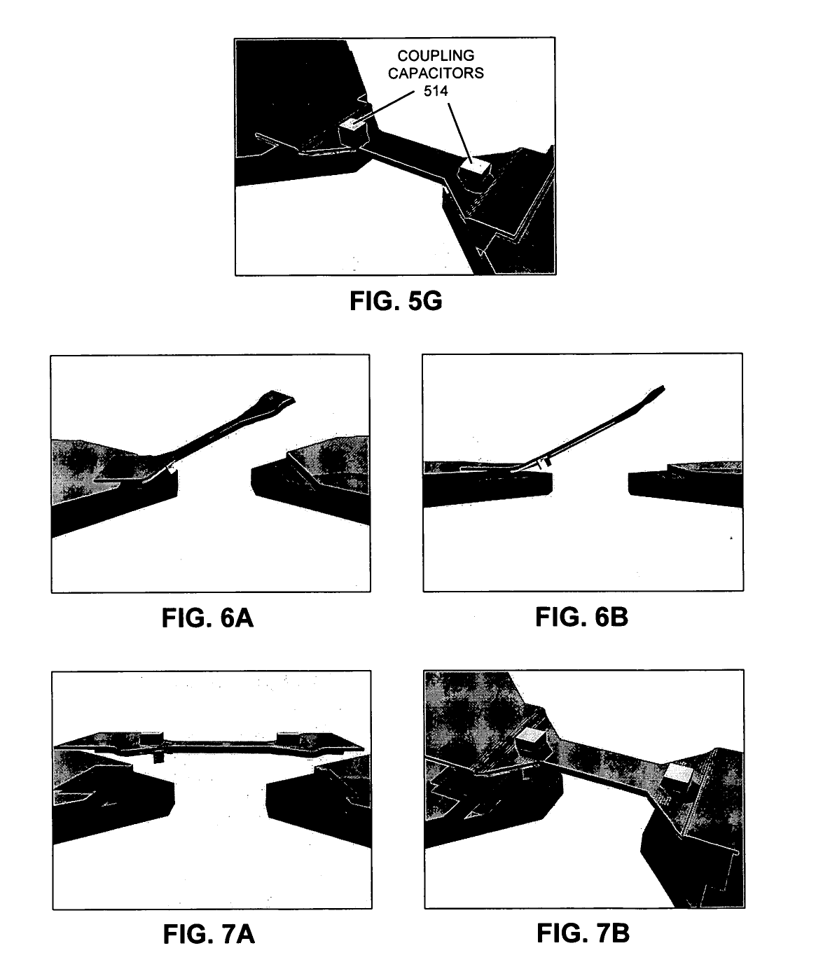

FIGS. 5A-5G illustrate the attachment and setup of a separable bridge chip. An embodiment in which the bridge chip can be easily attached or removed from the base chip can provide a way to insert or remove chip components without damage, for instance during assembly or rework. FIG. 5A illustrates the base chip 102 and the neighboring chip 104. FIG. 5B illustrates a rigid-flex cable 506 or some other power-delivery structure bonded to the two chips. FIG. 5C illustrates a thin active bridge chip 100 between the two chips. FIG. 5D illustrates attachment structures that connect the bridge chip to the base chip and neighboring chip. FIG. 5E illustrates two power delivery structures 510 located on the base chip and neighboring chips, while FIG. 5F illustrates a power delivery structure 512 that covers the bridge chip completely. FIG. 5G illustrates decoupling capacitors 514 that provide charge to the circuitry of the bridge chip.

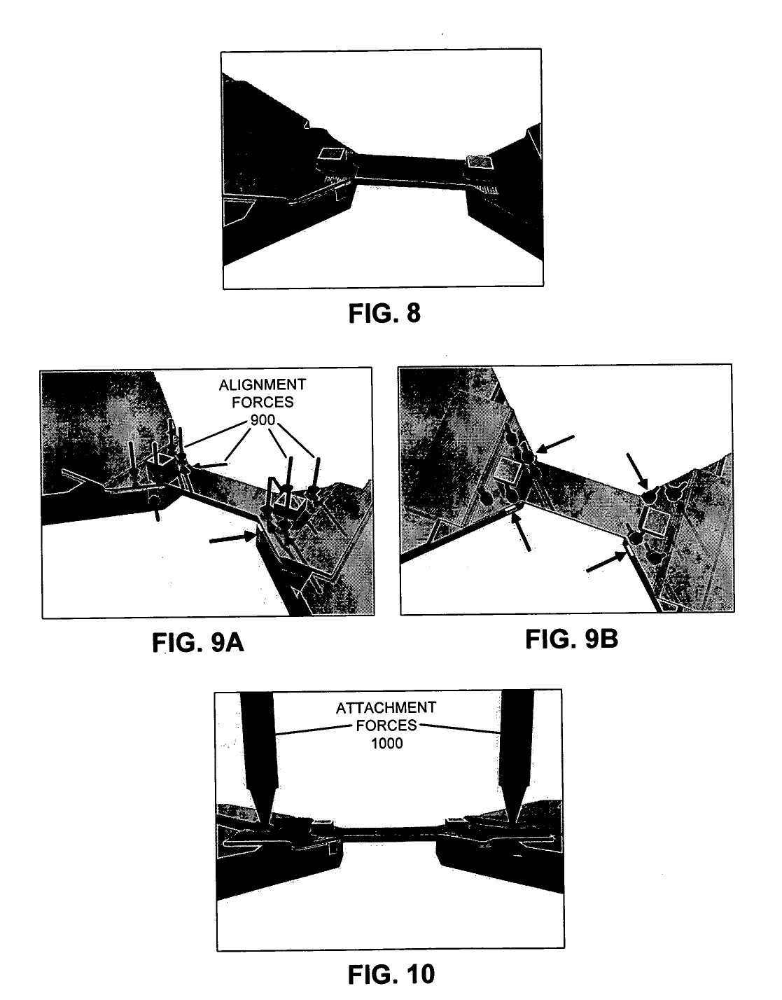

FIG. 6A and FIG. 6B illustrate two views of a flexible bridge chip. FIG. 7A and FIG. 7B illustrate two views of a separable bridge chip. FIG. 8 illustrates a bridge chip that is attached to the base chip and receives power from the base chip side, but is not attached to the neighboring chip. FIG. 9A and FIG. 9B illustrate the alignment forces 900 upon a bridge chip. FIG. 10 illustrates possible attachment forces 1000 for a bonded bridge chip. These attachment forces 1000 can include compression bonds and/or solder points.

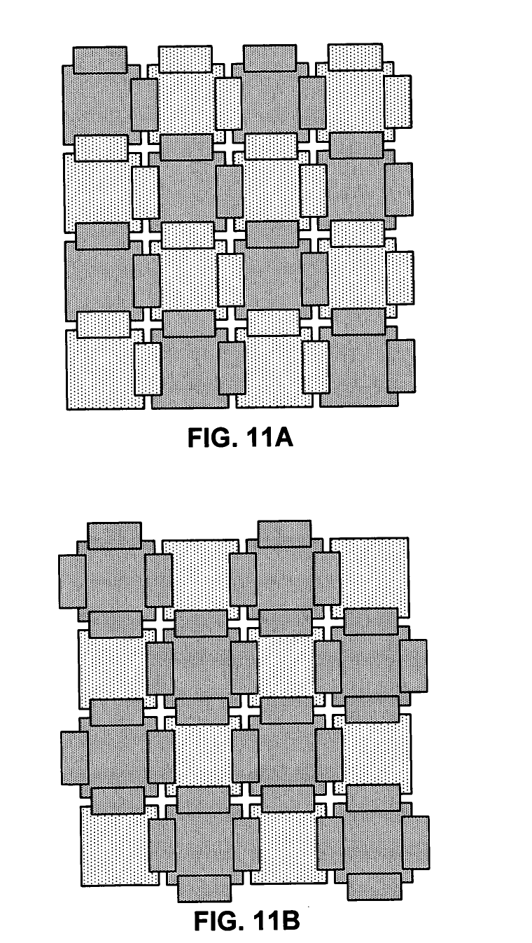

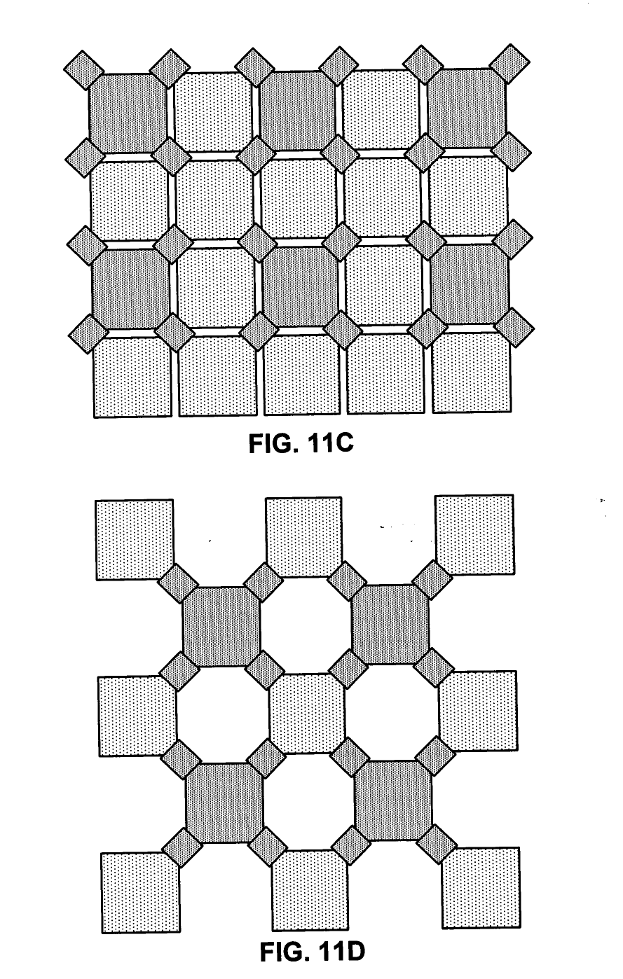

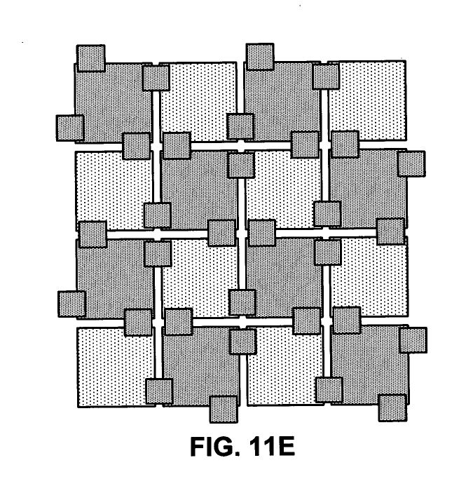

Sets of base chips can be organized in arrays that communicate using bridge chips and proximity communication. FIG. 11A-11E illustrate several possible tiling patterns for such arrays. FIG. 11A illustrates a multi-chip module composed of single-design host chips that have bridge chips attached on two sides. The drawback of this tiling approach is that in order to remove an arbitrary host chip from the array it may be necessary to remove a large number of chips.

FIG. 11B illustrates a different tiling concept in which there are two different types of host chips; one type acts as a host to four bridge chips, while the other type hosts no bridge chips. The advantage of this tiling pattern is that at most four chips have to be removed in order to remove an arbitrary chip from the array. Since the size of the host chip arrays may vary from several chips to as many as several hundred, this tiling pattern can result in a considerable improvement in the removal process.

FIG. 11C illustrates corner-mounted bridge chips which provide communication between chips in a full cubic array. An advantage of this configuration over the previous side-mounted configurations is that it enables communication with three neighboring chips. Furthermore, the positioning of corner-mounted bridge chips can reduce mechanical interference if rigid-flex cable structures are used to deliver power to the base chips. This configuration provides the same assembly/disassembly advantages described for FIG. 11B.

FIG. 11D provides an example of corner-mounted bridge chips that provide proximity communication between chips in an open cubic array. This open cubic array provides even more space for the routing of wider rigid-flex cables from power distribution structures to the chips, thereby allowing greater flexibility in integrating IC devices and other components onto the rigid-flex cable.

FIG. 11E illustrates a pinwheel tiling configuration with two different types of host chips. The pinwheel mounting of bridge chips on the base chip maximizes the continuous attachment area for rigid-flex cables.

Compared with corner-mounted bridge chips, the side-mounted bridge chips shown in FIGS. 11A, 11B, and 11E make possible an array of proximity communication pads that can extend over most of the length of the chip. This offers a more direct routing for the signal traces on the bridge chip from the bonded end to the free end of the bridge chip. Furthermore, side-mounted bridge chips also allow more direct routing for the signal traces on the host and neighboring chips as well.

Multi-Chip Modules and Power Distribution

Configuring chips in a single layer offers significant benefits for the module packaging objectives of chip alignment, thermal management, and power distribution. A supercomputer may require scores of ICs with many kilowatts of total power and cooling, and large numbers of external connections through scores of signal cables. The rigid-flex cable and the bridge chips facilitate arranging the base chips of an array of chips into a single, co-planar layer, with a second layer of smaller, low-power bridge chips providing proximity communication functionality between neighboring chips. This arrangement simplifies the design of the multi-chip module (MCM) considerably. Note that in some situations the use of a fixed bridge chip is unfeasible, and the use of separable bridge chips can provide an advantage.

Benefits of Bridge Chips

In summary, the advantages of bridge chips include (but are not limited to):
The use of bridge chips allows the primary chips of the MCM to be arranged in a single co-planar layer, which considerably simplifies alignment, thermal management, and power distribution for the MCM.
The bridge chip can compensate for perturbations in the base chip location and angles which are large compared to the required accuracy. Such compensations are especially applicable for alignment in the z-direction.
There are not excessive stresses on the bridge chip or the base chip.

The foregoing descriptions of embodiments of the present invention have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention. The scope of the present invention is defined by the appended claims.

What is claimed is:

1. A system, comprising:
a base chip with an active face upon which active circuitry and signal pads reside, and a back face opposite the active face; and
a bridge chip mounted to the base chip using a mounting and communication structure;
wherein the bridge chip is positioned so that a free end is proximate to a neighboring chip; and
wherein the bridge chip supports proximity communication between the base chip in the system and the neighboring chip.

2. The system of claim 1, wherein the bridge chip communicates with the neighboring chip using proximity communication techniques that include:
capacitive coupling across a thin gap using mating sets of capacitors;
optical communication using mating sets of optical transmitters and optical receivers;
magnetic coupling using mating sets of electromagnets;
short-wavelength microwave radiation; and/or
electromagnetic signals using mating sets of electromagnetic transmitters and receivers, wherein the electromagnetic signals may use various bands and modes of the electromagnetic spectrum.

3. The system of claim 1, wherein the bridge chip is mounted either to a corner or a side of the base chip.

4. The system of claim 1,
wherein the bridge chip has 2 ends and resembles a rectangle or a capital ‘I’;
wherein the bridge chip has 3 ends and resembles a capital ‘Y’; or
wherein the bridge chip has 4 ends and resembles either a capital ‘X’ or a small square.

5. The system of claim 1, wherein the bridge chip is thin enough to bend in the z-direction.

6. The system of claim 5,
wherein the bridge chip includes wiring deposited on a face of the bridge chip; and
wherein this wiring should be compliant and may include a spring layer than can bend elastically in the z-direction.

7. The system of claim 1,
wherein the bridge chip primarily supports communication, and thereby consumes less power than chips that support both computation and communication; and
wherein using bridge chips facilitates the layout of sets of multiple base chips in a single layer, thereby simplifying system design.

8. The system of claim 1, wherein the mounting and communication structure includes bonded and/or separable mountings for bridge chips.

9. The system of claim 1, wherein the mounting and communication structure includes mechanisms to support proximity communication and/or conductive communication.

10. The system of claim 1, wherein circuitry within the bridge chip can be either active or passive.

11. The system of claim 8, wherein the mounting and communication structure includes a conductive micro-bump mounting.

12. A computer system that includes:
a base chip; and
a bridge chip mounted to the base chip using a mounting and communication structure;
wherein the base chip includes an active face upon which active circuitry and signal pads reside, and a back face opposite the active face;
wherein the bridge chip is positioned so that a free end is proximate to a neighboring chip; and
wherein the bridge chip supports proximity communication between the base chip in the integrated circuit module and the neighboring chip.

13. The computer system of claim 12, wherein the bridge chip communicates with the neighboring chip using proximity communication techniques that include:
capacitive coupling across a thin gap using mating sets of capacitors;
optical communication using mating sets of optical transmitters and optical receivers;
magnetic coupling using mating sets of electromagnets;
short-wavelength microwave radiation; and/or electromagnetic signals using mating sets of electromagnetic transmitters and receivers, wherein the electromagnetic signals may use various bands and modes of the electromagnetic spectrum.

14. The computer system of claim 12, wherein the bridge chip is mounted either to a corner or a side of the base chip.

15. The computer system of claim 12,
wherein the bridge chip has 2 ends and resembles a rectangle or a capital ‘I’;
wherein the bridge chip has 3 ends and resembles a capital ‘Y’; or
wherein the bridge chip has 4 ends and resembles either a capital ‘X’ or a small square.

16. The computer system of claim 12, wherein the bridge chip is thin enough to bend in the z-direction.

17. The computer system of claim 16,
wherein the bridge chip includes wiring deposited on a face of the bridge chip; and
wherein this wiring should be compliant and may include a spring layer than can bend elastically in the z-direction.

18. The computer system of claim 12, wherein the mounting and communication structure includes bonded and/or separable mountings for bridge chips.

19. The computer system of claim 12, wherein the mounting and communication structure includes mechanisms to support proximity communication and/or conductive communication.

20. A method for manufacturing a system, comprising:
mounting a bridge chip to a base chip using a mounting and communication structure, wherein the base chip includes an active face upon which active circuitry and signal pads reside, and a back face opposite the active face;
wherein the bridge chip is positioned so that a free end is proximate to a neighboring chip; and
wherein the bridge chip supports proximity communication between the base chip in the integrated circuit module and the neighboring chip.
